(19) United States
(12) Patent Application Publication
(10) Pub. No.: US 2026/0077685 A1
(43) Pub. Date: Mar. 19, 2026

(54) DEVICE AND METHOD FOR DETERMINING SEAT OCCUPANCY

(71) Applicants: Hyundai Motor Company, Seoul (KR); Kia Corporation, Seoul (KR)

(72) Inventor: Young KIM, Hwaseong-si (KR)

(73) Assignees: Hyundai Motor Company, Seoul (KR); Kia Corporation, Seoul (KR)

(21) Appl. No.: 19/034,307

(22) Filed: Jan. 22, 2025

(30) Foreign Application Priority Data
Sep. 13, 2024 (KR) 10-2024-0125237

(51) Int. Cl. B60N 2/00

(52) U.S. Cl. CPC B60N 2/0035; B60N 2/0024; B60N 2/0033

(57) ABSTRACT

A device for determining seat occupancy includes a vibrator which is provided on a seat back of a vehicle seat and outputs a vibration signal, a detection unit that is provided on a seat bottom portion of the vehicle seat, receives the vibration signal transmitted through an object located on the vehicle seat, and generates a counting signal corresponding to the received vibration signal, and a processor that is configured to determine whether a vehicle occupant is seated on the vehicle seat by analyzing the counting signal.

### CROSS-REFERENCE TO RELATED APPLICATION

The present application claims priority to Korean Patent Application No. 10-2024-0125237, filed on Sep. 13, 2024, the entire contents of which is incorporated herein for all purposes by this reference.

### BACKGROUND OF THE PRESENT DISCLOSURE

### Field of the Present Disclosure

The present disclosure relates to a device and method for determining seat occupancy, and more specifically, to a device and method for determining seat occupancy that are capable of determining whether a vehicle seat is occupied.

### Discussion of Related Art

A vehicle occupant detection system (ODS) is a technology which is configured to detect the number and location of vehicle occupants inside a vehicle to provide safety and convenience. This system collects and analyzes accurate information by utilizing various types of sensors and algorithms. For example, in the present system, a technology that detects the weight of a vehicle occupant using a pressure sensor attached to a vehicle seat is utilized.

However, there is a problem that it is difficult to distinguish between a vehicle occupant and an object using a weight sensor located on the vehicle seat.

Furthermore, in the case of a linkage system that transmits vibration to a vehicle seat in connection with music, the linkage system may operate even when an object is present instead of a vehicle occupant, which may cause annoying noise.

Furthermore, when a lightweight vehicle occupant is seated, there may be cases where the system does not detect that the vehicle occupant is seated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device and method for determining seat occupancy that are configured for accurately determining whether each vehicle seat is occupied by a vehicle occupant.

The present disclosure is also directed to providing a device and method for determining seat occupancy that are configured for determining a physical condition of a vehicle occupant occupying a vehicle seat.

The present disclosure is also directed to providing a device and method for determining seat occupancy that are configured for determining an object occupying a vehicle seat.

The present disclosure is also directed to providing a device and method for determining seat occupancy that are configured for transmitting vibration to a vehicle seat in connection with output music.

According to various aspects of the present disclosure, there is provided a device for determining seat occupancy which includes a vibrator which is provided on a seat back of a vehicle seat and outputs a vibration signal, a detection unit which is provided on a seat bottom portion of the vehicle seat, receives the vibration signal transmitted through an object located on the vehicle seat, and generates a counting signal corresponding to the received vibration signal, and a processor that is configured to determine whether a vehicle occupant is seated on the vehicle seat by analyzing the counting signal.

The processor is configured to determine whether the vehicle occupant is seated and determine a height of the vehicle occupant by analyzing a frequency and a delay of the counting signal.

The processor is configured to determine a constituent material of the object located on the vehicle seat by analyzing the frequency and the delay of the counting signal.

The processor is configured to determine that the vehicle occupant is seated on the vehicle seat when the frequency of the counting signal is the same as a frequency of the vibration signal within a predetermined error range and the delay of the counting signal is within a predetermined reference range.

The processor is configured to determine the height of the vehicle occupant using a delay value of the counting signal.

The processor is configured to determine the constituent material of the object using a delay value of the counting signal.

The processor is configured for controlling an operation of the vibrator so that a first frequency of the vibration signal is different from a second frequency generated during engine vibration.

The detection unit may include a mat including a liquid that moves in connection with the vibration signal and a sensor that produces the counting signal according to pressure generated by the movement of the liquid.

The detection unit may include a first detection unit and a second detection unit disposed at locations corresponding to both thighs of the vehicle occupant.

The processor is configured to determine whether the vehicle occupant is seated on the vehicle seat by comparing and analyzing a first counting signal generated by the first detection unit and a second counting signal generated by the second detection unit.

The processor is configured for controlling the operation of the vibrator provided on the vehicle seat where the vehicle occupant is seated in connection with music.

According to various aspects of the present disclosure, there is provided a method of determining seat occupancy including outputting, by a vibrator provided on a seat back of a vehicle seat, a vibration signal, receiving, by a detection unit provided on a seat bottom portion of the vehicle seat, the vibration signal transmitted through an object located on the vehicle seat, generating a counting signal corresponding to the vibration signal received by the detection unit, and determining, by a processor, whether a vehicle occupant is seated on the vehicle seat by analyzing the counting signal.

In the determining of whether the vehicle occupant is seated, the processor is configured to determine that the vehicle occupant is seated on the vehicle seat when a frequency of the counting signal is the same as a frequency of the vibration signal within a predetermined error range and a delay of the counting signal is within a predetermined reference range.

The method may further include determining, by the processor, a height of the vehicle occupant by analyzing a frequency and a delay of the counting signal.

In the determining of the height of the vehicle occupant, the processor is configured to determine the height of the vehicle occupant using a delay value of the counting signal.

The method may further include determining, by the processor, a constituent material of the object located on the vehicle seat by analyzing a frequency and a delay of the counting signal.

In the determining of the constituent material of the object, the processor is configured to determine the constituent material of the object using a delay value of the counting signal.

The outputting of the vibration signal may include controlling, by the processor, an operation of the vibrator so that a first frequency of the vibration signal is different from a second frequency generated during engine vibration.

The determining of whether the vehicle occupant is seated on the vehicle seat may include determining, by the processor, whether the vehicle occupant is seated on the vehicle seat by comparing and analyzing a first counting signal generated by a first detection unit and a second counting signal generated by a second detection unit.

The method may further include controlling, by the processor, an operation of the vibrator provided on the vehicle seat where the vehicle occupant is seated in connection with music.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a vehicle communicating with other devices to transmit and receive data.

FIG. 2 is a diagram illustrating modules forming a vehicle according to an exemplary embodiment of the present disclosure.

FIG. 3 is a configuration block diagram of a device for determining seat occupancy according to an exemplary embodiment of the present disclosure.

FIG. 4 is a conceptual diagram of a vehicle seat according to an exemplary embodiment of the present disclosure.

FIG. 5 is a diagram for describing a detection unit according to an exemplary embodiment of the present disclosure.

FIG. 6, FIG. 7 and FIG. 8 show diagrams for describing an operation of a processor according to an exemplary embodiment of the present disclosure.

FIG. 9 is a conceptual diagram of a device for determining seat occupancy according to another exemplary embodiment of the present disclosure.

FIG. 10 is a diagram for describing an operation of a device for determining seat occupancy according to another exemplary embodiment of the present disclosure.

FIG. 11 is a flowchart of a method of determining seat occupancy according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical idea of the present disclosure is not limited to few embodiments described, but may be implemented in various different forms, and within the scope of the technical idea of the present disclosure, one or more components of embodiments may be selectively combined or substituted for use between the embodiments.

Furthermore, terms (including technical and scientific terms) used in the exemplary embodiments of the present disclosure, unless explicitly and specifically defined and described, may be interpreted as having meanings which may be generally understood by a person of ordinary skill in the field of the present disclosure to which an exemplary embodiment of the present disclosure belongs, and the meanings of commonly used terms, such as terms defined in a dictionary, may be interpreted based on the contextual meaning of the related technology.

Furthermore, terms used in embodiments of the present disclosure are for describing the exemplary embodiments and are not intended to limit the present disclosure.

In the present specification, singular forms may also include plural forms unless specifically stated in the phrase, and a phrase “at least one (or more) of A, B and C,” may include one or more of all possible combinations of A, B, and C.

Furthermore, terms such as “first,” “second,” “A,” “B,” “(a),” “(b),” etc., may be used to describe components of embodiments of the present disclosure.

These terms are only intended to distinguish the components from other components, and do not limit the nature, order, or sequence of the components.

Furthermore, when a component is said to be “connected,” “joined” or “coupled” to another component, this may include not only direct connection, joining, and coupling relationships between the component and the other component, but also indirect connection, joining, and coupling relationships where another component exists in between.

Furthermore, when a component is said to be formed or disposed “above (over)” or “below (under)” another component includes not only the case where the two components are in direct contact with each other, but also the case where one or more other components are formed or disposed between the two components. When expressed as “above (over)” or “below (under),” it may include the meaning of not only the upward direction but also the downward direction based on one component.

Hereinafter, various exemplary embodiments will be described in detail with reference to the accompanying drawings, but identical or corresponding components will be provided the same reference numerals throughout the drawings, and redundant descriptions thereof will be omitted.

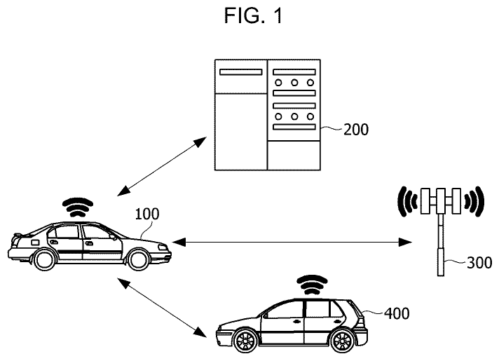

FIG. 1 is a diagram illustrating a vehicle communicating with another device to transmit and receive data.

Referring to FIG. 1, a vehicle 100 may be driven by electrical energy or fossil energy. When powered by electrical energy, the vehicle 100 may be, for example, a pure battery-based vehicle driven only by a high-voltage battery, or may employ a gas-based fuel cell as an energy source. Furthermore, the fuel cell may utilize various forms of gas configured for generating electrical energy, and the gas may be filled into the vehicle 100 in a liquefied state, for example. Here, the gas may be hydrogen, for example. However, the present disclosure is not limited thereto, and various gases may be adopted. When powered by fossil energy, the vehicle 100 may be powered by fuel such as gasoline, diesel, or liquefied gas, and may be provided with an internal combustion engine that drives an actuating unit 116 by combustion of the fuel. The engine may be included in an energy generation unit 110 from the perspective of providing driving rotational power of wheels to a wheel drive unit 118. As an exemplary embodiment of the present disclosure, the vehicle 100 may selectively utilize the energy of a fossil fuel-based internal combustion engine and electric battery to drive the actuating unit 116, and the vehicle 100 may be a hybrid type of vehicle.

The vehicle 100 may be a mobile device. The vehicle 100 is a ground vehicle that travels on the ground, and may be a typical passenger vehicle or commercial vehicle, a purpose built vehicle (PBV), etc. The vehicle 100 may be a four-wheeled vehicle, such as a passenger vehicle, a sports utility vehicle (SUV), a small truck, or a vehicle with more than four wheels, for example, a bus, a large truck, a container transport vehicle, a heavy equipment vehicle, etc. Here, examples of the ground vehicle may include not only a vehicle that moves on land, but also a vehicle that moves underground. The vehicle 100 may be a robot in a broad sense, such as a means of movement, and the robot may be moved using wheels, tracks, or other movement modules. In an exemplary embodiment of the present disclosure, a ground mobility device such as the ground vehicle is mainly described, but unless otherwise inconsistent with the present disclosure, the exemplary embodiment of the present disclosure may also be applied to an air mobility device such as advanced air mobility (AAM), an aircraft, and a water mobility device such as a ship, a submarine, or the like.

The vehicle 100 may be controlled and driven by autonomous driving, and autonomous driving may be implemented as semi-autonomous driving or fully autonomous driving. Fully autonomous driving may be provided as autonomous movement in which a processor 122 of the vehicle 100 has full control without user intervention, even when a driving situation is uncertain. Semi-autonomous driving may be provided as autonomous movement that requires driver intervention depending on a specific driving situation. Semi-autonomous driving may be implemented so that the processor 122 deactivates autonomous driving when the driving situation occurs and transfers control to the user, allowing a user to perform manual driving. According to the level of autonomous driving defined by the American Society of Automotive Engineers (SAE), semi-autonomous driving corresponds to autonomous driving levels 1 to 4, and fully autonomous driving corresponds to level 5.

Meanwhile, the vehicle 100 may perform communication with other devices 200 and 300 or other vehicles 400. Other devices may include, for example, a server 200 that supports various controls, state management, and driving of the vehicle 100, an intelligent transportation system (ITS) device 300 for receiving information from an ITS, various types of user devices, etc. The server 200 including at least a processor is, for example, an external device operated by a vehicle manufacturer or provided to service autonomous driving, and may receive connected data of the vehicle 100 or transmit data necessary for autonomous driving. The server 200 may transmit various types of information and software modules used for controlling the vehicle 100 to the vehicle 100 in response to a request and data transmitted from the vehicle 100 and the user device to support autonomous driving of the vehicle 100 and various services.

The ITS device 300 is, for example, a road side unit (RSU), and may exchange vehicle recognition data, driving control and state data, environmental data from around the vehicle, map data, etc., with the vehicle 100 through vehicle-to-infrastructure (V2I) to assist the user with driving or support autonomous driving of the vehicle 100. The vehicle 100 may exchange the data listed above with other vehicles 400 through Vehicle-To-Vehicle (V2V) to support manual driving or autonomous driving.

The vehicle 100 may perform communication with other vehicles or other devices based on cellular communication, Wireless Access in Vehicular Environment (WAVE) communication, Dedicated Short Range Communication (DSRC) or short-range communication, or other communication methods.

For example, the vehicle 100 may use a cellular communication network such as Long Term Evolution (LTE), 5G, Wireless Fidelity (WiFi), or WAVE for communication with the server 200, ITS device 300, or other vehicles 400. As an exemplary embodiment of the present disclosure, the DSRC, etc., used in the vehicle 100 may also be used for communication between vehicles. The communication method between the vehicle 100, the server 200, the ITS device 300, other vehicles 400, and user devices is not limited to the above-described embodiment.

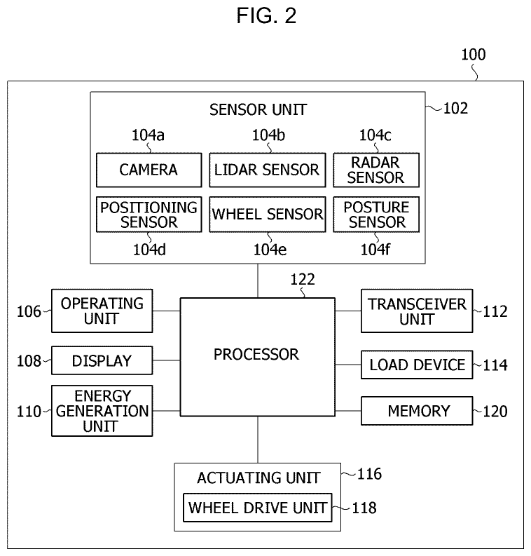

FIG. 2 is a diagram illustrating modules forming a vehicle 100 according to an exemplary embodiment of the present disclosure.

The vehicle 100 may include a sensor unit 102, an operating unit 106, a display 108, a load device 114, and a transceiver unit 112.

The sensor unit 102 may be provided with various types of detectors for detecting various types of states and situations occurring in an external environment, internal system, and boarding space of the vehicle 100, and according to user operation thereof.

The sensor unit 102 may be provided with an externally facing camera 104a, a Light Detection and Ranging (LiDAR) sensor 104b, a radio detection and ranging (RADAR) sensor 104c, etc., to detect dynamic and static objects existing outside the vehicle 100. The camera 104a may detect an external object as an image during use of the vehicle 100 to generate image data and transmit the image data to the processor 122. The LiDAR sensor 104b may be configured to generate point cloud data as detected data of an external object and transmit the point cloud data to the processor 122 to generate three-dimensional spatial information that identifies at least a shape of the external object. The radar sensor 104c may be configured to generate radar data through radio waves obtained by emitting radio waves of a specific frequency around the vehicle 100 and receiving the waves reflected from an external object to determine the existence of an external object, a relative distance, speed, and direction thereof, etc. Although the present disclosure is illustrated as including the LiDAR sensor 104b, in other examples, the LiDAR sensor 104b may not be mounted.

The sensor unit 102 may be provided with a positioning sensor 104d, a wheel sensor 104e, and a posture sensor 104f to check the vehicle's own position, speed, driving posture, etc. The posture sensor 104f may include a gyro sensor, an angular velocity sensor, an acceleration sensor, etc.

In an exemplary embodiment of the present disclosure, sensors of the sensor unit 102 referred to in the description of the exemplary embodiment are mainly described, but sensors that detect various types of situations not listed here may be additionally included.

The operating unit 106 may be formed as a module for the user to control driving. For example, the operating unit 106 may be a steering wheel, an automatic or manual transmission, an accelerator pedal, a brake pedal, etc., for manual driving. The operating unit 106 may further be provided with an interface for using, releasing, and selecting detailed functions of autonomous driving mode requested by the user for the user to use an autonomous driving function. The operating unit 106 may be formed as, for example, a hard type interface provided at a predetermined location inside the vehicle 100 or a soft type interface configured for being touched on a display 108 to receive various types of requests related to autonomous driving. The hard type interface refers to rigid, fixed user interfaces, such as physical buttons or dedicated hardware panels. In contrast, the soft type interface is more flexible and dynamic, like touchscreens or software-based interfaces on smartphones, where layouts can change depending on the application. Depending on the specifications of the autonomous vehicle, at least one of the steering wheel, transmission, and pedals may be omitted. As an exemplary embodiment of the present disclosure, the operating unit 106 may be provided with a module that receives a user's control request for the load device 114 in addition to driving control.

The display 108 may function as a user interface. The display 108 may be controlled by the processor 122 to output and display an operation state, control state, route/traffic information, remaining energy amount information, content requested by the driver, etc., of the vehicle 100 thereon. Furthermore, the display 108 may be formed as a touch screen configured for detecting driver input, and may receive a driver's request to instruct the processor 122.

The load device 114 is mounted on the vehicle 100 and may be a type of non-driving electric device excluding a driving power system such as a wheel drive unit 118. The load device 114 is an auxiliary device that receives power from the energy generation unit 110, and may be, for example, an air conditioning system, a lighting system, a vehicle seat system, and various devices provided on the vehicle 100. In an exemplary embodiment of the present disclosure, a cooling/heating system that cools or heats at least one of a battery, a fuel cell, an internal combustion engine, an air conditioning system, and a specific part of the vehicle 100 may be further included.

The transceiver unit 112 may support mutual communication with the server 200, the ITS device 300, the surrounding vehicles 400, etc. The transceiver unit 112 may include a module that processes, for example, cellular communication, the WAVE communication, the DSRC, etc. In an exemplary embodiment of the present disclosure, the transceiver unit 112 may transmit data generated or stored while driving to the server 200, and receive data and software module transmitted from the server 200. The transceiver unit 112 may also support communication with an electronic device carried by a vehicle occupant inside the vehicle 100. In an exemplary embodiment of the present disclosure, the vehicle 100 may transmit and receive data utilized in the method according to an exemplary embodiment of the present disclosure to or from the outside thereof through the transceiver unit 112.

Furthermore, the vehicle 100 may include the energy generation unit 110 and the actuating unit 116.

The energy generation unit 110 may be configured to generate and supply motive power and electric power used in a driving power system such as the actuating unit 116 and a non-driving power system. The non-driving power system may include, for example, the sensor unit 102, the operating unit 106, the display 108, the load device 114, and the transceiver unit 112, and may include, without being limited to the above components, various components that implement sensing, interface, communication, and convenience functions, excluding components directly involved in driving operations.

When the vehicle 100 is powered by electrical energy, the energy generation unit 110 may be formed with, for example, an electric battery charged from the outside thereof, or a combination of an electric battery and fuel cells for charging the electric battery. The energy generation unit 110 formed with the combination of an electric battery and fuel cells may include a tank that stores a material used to produce power for the fuel cell, for example, liquefied hydrogen. When the vehicle 100 is powered by fossil energy, the energy generation unit 110 may be formed with an internal combustion engine. Furthermore, when the vehicle 100 is a hybrid type of vehicle, the energy generation unit 110 may be provided as a combination of the internal combustion engine and the electric battery.

The actuating unit 116 may be provided with at least one module implementing a driving operation, and may perform at least one driving operation among longitudinal control such as acceleration and deceleration and lateral control such as steering, according to a user request from the operating unit 106. The actuating unit 116 may be provided with the wheel drive unit 118, a mechanical component and an electronic module for implementing the driving operation in the wheel drive unit 118 to perform the driving operation according to an instruction of the processor 122 by a user's manual operation or autonomous driving. When the vehicle 100 is operated based on electrical energy, the actuating unit 116 may include an assembly for transmitting a requested driving operation to the wheel drive unit 118. The assembly for transmitting the requested driving operation by electrical energy to the wheel drive unit 118 typically includes a motor, a power transmission mechanism, and control systems. The motor converts electrical energy into mechanical energy, which is then transferred to the wheels through components such as a gearbox, driveshafts, or direct drive mechanisms. The assembly may also include in-wheel motors in some designs, where the motor is integrated directly into the wheel hub for improved efficiency and compactness.

When the vehicle 100 is operated based on fossil energy, the actuating unit 116 may be provided with a transmission and gear module that transmit power of the internal combustion engine.

The wheel drive unit 118 may include a plurality of wheels, a driving force generation module for generating driving force and applying or transmitting the driving force to the wheels, a braking module for decelerating driving of the wheels, and a steering module for realizing lateral control of the wheels. When the vehicle 100 is powered by electrical energy, the driving force generation module may be formed as a motor assembly that generates driving force based on electric power output from an electric battery. The braking module of the electric-based vehicle 100 may further include a regenerative braking function.

The memory 120 stores an application and various types of data for controlling the vehicle 100, and the application may be loaded from the memory 120 or data may be read therefrom and written thereon at the request of the processor 122.

The processor 122 may perform overall control of the vehicle 100. The processor 122 may be configured to execute the application and instructions stored in the memory 120.

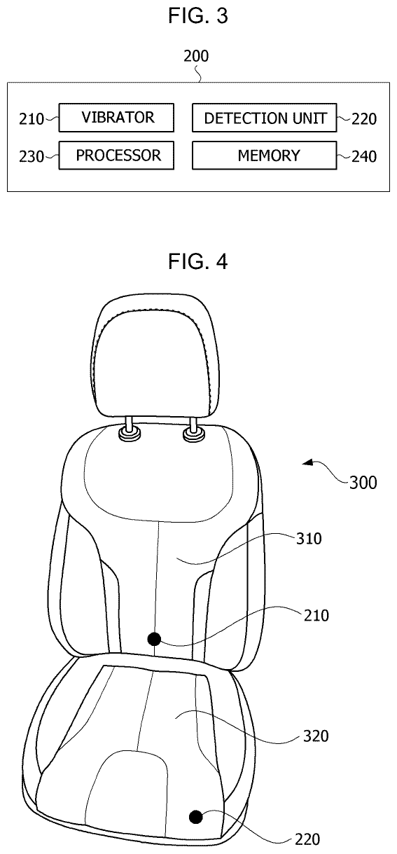

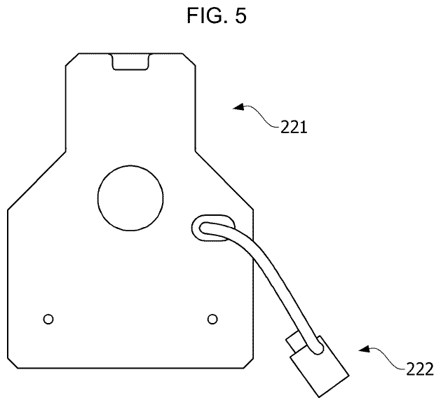

FIG. 3 is a configuration block diagram of a device for determining seat occupancy according to an exemplary embodiment and FIG. 4 is a conceptual diagram of a vehicle seat according to an exemplary embodiment of the present disclosure. Referring to FIG. 3 and FIG. 4, a device 200 for determining seat occupancy according to various exemplary embodiments of the present disclosure may include a vibrator 210, a detection unit 220, a processor 230, and a memory 240. The device for determining seat occupancy according to various exemplary embodiments of the present disclosure may be implemented in a vehicle. Unless otherwise described, the processor 230 and the memory 240 of FIG. 3 will be described as having the same configuration as the processor and the memory of FIG. 2.

The vibrator 210 may be provided in a seat back 310 of a vehicle seat 300 and output a vibration signal. The vibrator 210 may be disposed by being embedded in an empty space of the seat back 310 of the vehicle seat 300, and at least one vibrator 210 may be disposed on the seat back 310 to be spaced apart with a predetermined distance. Each vibrator 210 operates independently under the control of the processor 230 and may output a predetermined vibration signal.

For example, the vibrator 210 may be formed in a form including a frame forming an exterior, a voice coil provided inside the frame and forming a magnetic field when an electric signal is applied, at least one magnet which vibrates with a certain frequency by interacting with others through a magnetic field of the voice coil, and a vibrating body that transmits vibration of the magnet to the human body, etc. When an electric signal is applied to the voice coil of the vibrator 210 under the control of the processor 230, a magnetic field proportional to the intensity of an electric signal is formed in the voice coil, and as the present magnetic field interacts with the magnet, the magnet vibrates up and down at a predetermined frequency. When these vibration signals are output through the vibrating body and transmitted to the human body, the human body recognizes a certain acoustic signal.

The detection unit 220 is provided on a seat bottom 320 of the vehicle seat, and may receive a vibration signal transmitted through an object located on the vehicle seat 300 and generate a counting signal corresponding to the received vibration signal.

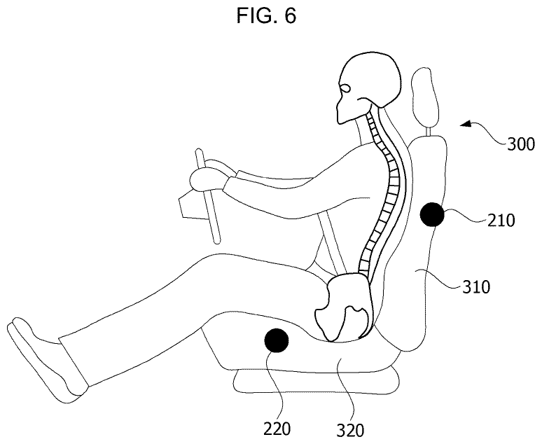

FIG. 5 is a diagram for describing a detection unit according to an exemplary embodiment of the present disclosure. Referring to FIG. 5, the detection unit 220 may include a mat 221 including liquid that moves in connection with a vibration signal and a sensor 222 that generates a counting signal according to the pressure generated by the movement of the liquid. The mat 221 may be filled with silicone liquid. The mat 221 is a thin and flexible mat, and may be formed with compartments (bladders) filled with fluid and may be disposed under the seat bottom 320. When a vehicle occupant sits on a vehicle seat, the bladder is compressed due to the weight and pressure of the vehicle occupant, which causes the fluid to move.

The sensor 222 may be a silicon drift pressure sensor (SDPS), and may detect shaking due to a minute force applied to the top portion of the mat 221. The SDPS sensor 222 may be made of silicon which may accurately measure pressure changes, and may operate sensitively and detect subtle pressure changes. When used with the bladder mat 221, the SDPS sensor 222 may accurately measure the pressure exerted by the vehicle occupant. The present sensor 222 provides a detailed pressure map of the vehicle seat 300, measures the movement and distribution of fluid inside the bladder, and provides information with which the presence, weight, and distribution of vehicle occupants may be determined. The present information may be used to distinguish between adults, children, and inanimate objects.

In the exemplary embodiment of the present disclosure, an example of determining a seat occupancy situation using one vibrator 210 provided on the seat back 310 of the vehicle seat 300 and one detection unit 220 provided on the seat bottom 320 thereof will be described.

The processor 230 may analyze the counting signal to determine whether a vehicle occupant is seated on the vehicle seat. For example, the processor 230 may be configured to determine that the vehicle occupant is seated on the vehicle seat 300 when a frequency of the counting signal is the same as the frequency of the vibration signal within a predetermined error range and a delay of the counting signal is within a predetermined reference range.

Furthermore, the processor 230 may analyze the frequency and the delay of the counting signal to determine whether a vehicle occupant is seated and determine a height of the vehicle occupant. For example, the processor 230 may be configured to determine the height of the vehicle occupant using a delay value of the counting signal.

Furthermore, the processor 230 may analyze the frequency and the delay of the counting signal to determine a constituent material of an object located on the vehicle seat 300. For example, the processor 230 may use the delay value of the counting signal to determine the constituent material of the object.

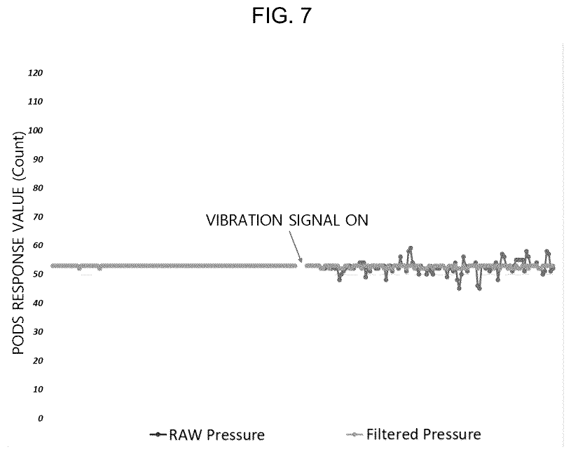

FIG. 6, FIG. 7 and FIG. 8 show diagrams for describing an operation of a processor according to an exemplary embodiment of the present disclosure.

Referring to FIG. 6, FIG. 7, and FIG. 8 together, when a vehicle occupant sits on the vehicle seat 300, a bladder mat 221 is compressed, and the movement of fluid contained within the bladder mat 221 changes the pressure distribution. When the vibrator 210 mounted on the vehicle seat back 310 outputs a vibration signal, the vibration signal may be transmitted to the detection unit 220 through the bones of the vehicle occupant. The detection unit 220 may detect the present change in real time and generate a counting signal as shown in FIG. 7. FIG. 7 is a graph in which the horizontal axis represents time [sec] and the vertical axis represents an amount of pressure change converted into a count number.

That is, when the vibrator 210 is not operating, the weight is continuously maintained in a state where a zero point is adjusted to 50 kg, and when something is placed on the vehicle seat, a person is seated thereon, or an object is placed on, the zero point adjustment weight increases. When the state in which the vibrator 210 is not operating is maintained, in the graph, a state in which the zero point is adjusted is maintained. In the instant state, when the vibrator 210 operates and the vibration signal of the vibrator 210 is transmitted to the detection unit 220 through the body of the vehicle occupant, the liquid contained within the bladder mat 221 shakes according to a vibration frequency of the signal and the weight slightly changes, and the sensor 222 may count an amount of weight change.

The processor 230 may analyze a time difference between a first time point at which the vibrator 210 outputs the vibration signal and a second time point at which the detection unit 220 detects the vibration signal and generates the counting signal to determine whether the vehicle occupant is seated, the height of the vehicle occupant, and the constituent material of the object.

Referring to FIG. 8, the vibration signal has a different transmission speed depending on the type of medium, and the processor 230 may be configured to determine that the vehicle occupant is seated on the vehicle seat 300 when the time difference between the first time point and the second time point is within a preset first time period. The first time period may be set using the transmission speeds in the vertebrae and femur of FIG. 8 and the results of preliminary experiments. In the instant case, the processor 230 may be configured to determine whether the vehicle occupant is seated and determine the height of the vehicle occupant by utilizing data stored in a form of a lookup table in which the height of the person and the transmission speed of the vibration signal are matched.

Furthermore, the processor 230 may be configured to determine that the greater the time difference between the first time point and the second time point within the first time period, the greater the height of the vehicle occupant. This is because the longer the height of the vehicle occupant, the longer it takes for the vibration signal to be transmitted from the vibrator 210 to the detection unit 220.

Furthermore, when the time difference between the first time point and the second time point is within a second time period, the processor 230 may be configured to determine the constituent material of the object by dividing the second time period into sections. The second time period may be divided into a plurality of sections and set in advance to correspond to the transmission speed of the vibration signal according to the type of medium in FIG. 8. The second time period may be a time section different from the first time period. The second time period may be set using the transmission speed of the media such as steel, aluminum, copper, glass, diamond, concrete, etc., in FIG. 8 and the results of preliminary experiments.

Furthermore, when the counting signal is not received, the processor 230 may be configured to determine that no object other than a person is placed on the vehicle seat 300 or that no vehicle occupant is seated thereon.

Alternatively, the processor 230 may be configured to determine that an object is not placed on the vehicle seat 300 or that a vehicle occupant is not seated thereon when the time difference between the first time point and the second time point is within a third time period. The third time period may be determined according to the transmission speed of the vibration signal when the medium is air. That is, the processor 230 may be configured to determine that an object is not placed on the vehicle seat 300 or that a vehicle occupant is not seated when the vibration signal is transmitted through air.

In the exemplary embodiment of the present disclosure, the first time period, the second time period, and the third time period may be set in advance according to FIG. 8 and the experiments and stored in the memory.

The processor 230 may be configured for controlling an operation of the vibrator so that a first frequency of the vibration signal is different from a second frequency generated during engine vibration. When a frequency of the counting signal is the same as the frequency generated during engine vibration, an error may occur in a process of analyzing the counting signal. Therefore, the processor 230 may be configured for controlling the vibrator to output a frequency different from that of the vibration signal. When the frequency of the counting signal matches the second frequency component, the processor 230 analyzes whether the vehicle occupant is seated, the height of the vehicle occupant, and the constituent material of the object.

Alternatively, the processor 230 may filter the first frequency occurring during engine vibration and then analyze the counting signal. That is, the processor 230 may perform a Fast Fourier Transform on the counting signal, remove a frequency component corresponding to the first frequency, and then analyze the counting signal, preventing an analysis error occurring due to engine vibration.

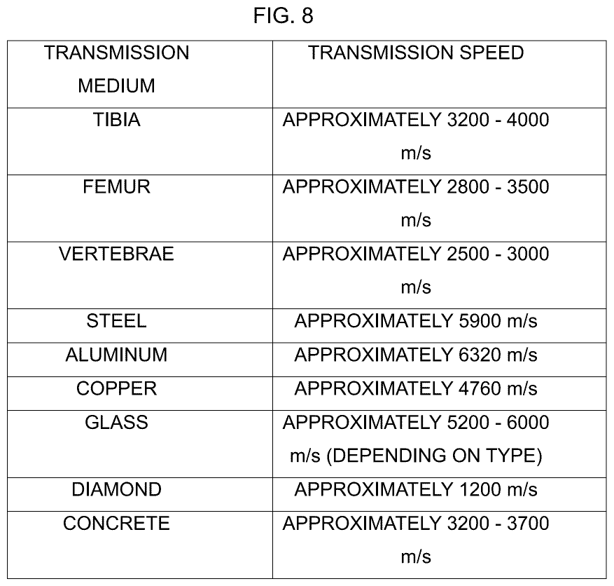

FIG. 9 is a conceptual diagram of a device for determining seat occupancy according to another exemplary embodiment of the present disclosure. Referring to FIG. 9, in the exemplary embodiment of the present disclosure, a detection unit may include a first detection unit 2210 and a second detection unit 2220 disposed at locations corresponding to both thighs of the vehicle occupant. The detection units 2210 and 2220 may independently receive vibration signals output from a vibrator 2100 provided on a seat back 3100 and respectively generate a first counting signal and a second counting signal.

The processor may compare and analyze the first counting signal generated by the first detection unit 2210 and the second counting signal generated by the second detection unit 2220 to determine whether the vehicle occupant is seated on the vehicle seat 3000.

For example, the processor may be configured to determine a signal obtained by adding and averaging the first counting signal and the second counting signal and analyze whether the vehicle occupant is seated, the height of the vehicle occupant, and the constituent material of the object using the frequency and the delay of the averaged signal.

Alternatively, the processor may analyze whether the vehicle occupant is seated, the height of the vehicle occupant, and the composition material of the object using a signal value exceeding a preset threshold among the first counting signal and the second counting signal. The threshold is a value determined in advance according to an experiment and may be determined as a threshold of the counting signal for accurately analyzing whether the vehicle occupant is seated. For example, when an average value of count values (pressure change amounts) of the first counting signal is less than a threshold and an average value of count values of the second counting signal is greater than or equal to the threshold, the processor may analyze whether the vehicle occupant is seated, the height of the vehicle occupant, and the constituent material of the object using the second counting signal.

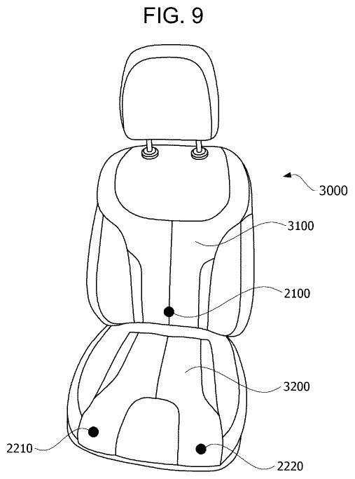

FIG. 10 is a diagram for describing an operation of a device for determining seat occupancy according to another exemplary embodiment of the present disclosure. Referring to FIG. 10, a device 200 for determining seat occupancy according to the exemplary embodiment of the present disclosure may include a vibrator 210, a detection unit 220, a processor 230, a memory 240, and a signal processing unit 250.

The processor 230 may receive corresponding sound source data (e.g., MP3 data) stored in the memory according to the user's music playback input and provide the sound source data to the signal processing unit 250.

The signal processing unit 250 may analyze the sound source data and perform signal processing to convert the sound source into vibration in the vibrator 210 for bone conduction and transmit the vibration to the human body.

As described above, the processor 230 may be configured to determine whether the vehicle occupant is seated on each vehicle seat through the counting signal of the detection unit 220, and control the vibrator 210 of the vehicle seat where the vehicle occupant is seated so that a vibration signal corresponding to the sound source is output. In the instant case, the processor 230 may perform control so that the vibration signal is not output to a vehicle seat where an object other than a person is disposed. Furthermore, the processor 230 may adjust the magnitude of the vibration signal according to the height of the vehicle occupant. For example, the processor 230 may increase the magnitude of the vibration signal in proportion to the height of the vehicle occupant according to the height determination result of the vehicle occupant. That is, in the case of a child whose height is smaller than that of an adult, a vibration signal with relatively reduced magnitude may be output.

Through this, the device 200 for determining seat occupancy according to the exemplary embodiment of the present disclosure may output the vibration signal linked with music only when a person is seated on the vehicle seat, and may estimate the age of the vehicle occupant and transmit a vibration signal suitable therefor.

The sound source processed through the signal processing unit 250 may be processed and output according to the location and number of each vibrator 210. For example, a plurality of vibrators 210 may be disposed on the seat back, and the signal processing unit 250 may perform signal processing on sound source data (e.g., MP3 data) received through the processor 230 to correspond to the location of each vibrator.

The signal processing unit 250 may analyze the received sound source data and extract and amplify a signal of a specific frequency to transmit the signal of the specific frequency to the vibrator 210 at a specific position thereof. The signal extracted to be transmitted to a specific vibrator 210 may be amplified and then transmitted to the corresponding vibrator 210.

Each vibrator 210 may convert sound source data of the specific frequency transmitted by the signal processing unit 250 into a vibration signal. The vibration signal generated by each vibrator 210 is transmitted to the skull through the bones of the vehicle occupant seated in the vehicle seat, and the vibrations transmitted to the skull may be transmitted to the cochlea. The vibrations transmitted to the cochlea cause the vibrations of the lymph fluid filled in the cochlea to be converted into electrical signal and transmitted to the auditory nerve, so that the vehicle occupant becomes able to recognize the sound.

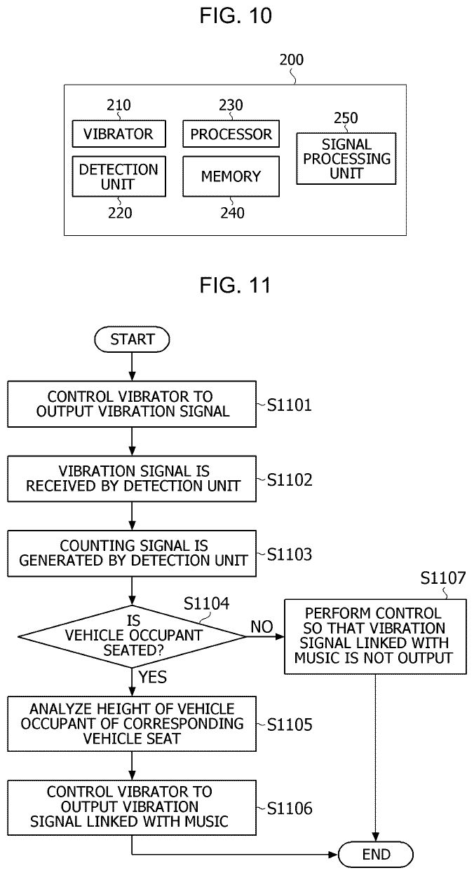

FIG. 11 is a flowchart of a method of determining seat occupancy according to an exemplary embodiment of the present disclosure.

Referring to FIG. 11, the processor is configured to control a vibrator provided on a seat back of a vehicle seat to output a vibration signal. The processor is configured for controlling the vibrator to output a vibration signal according to a second frequency different from a first frequency of a signal generated during engine vibration. In some cases, the processor is configured for controlling the vibration signal to be output only to the remaining seats except for the driver's seat (S1101).

Next, a detection unit provided on the seat bottom portion of the vehicle seat receives a vibration signal transmitted through an object located on the vehicle seat (S1102).

Next, the detection unit generates a counting signal corresponding to the received vibration signal (S1103).

Next, the processor analyzes the counting signal to determine whether a vehicle occupant is seated on the vehicle seat (S1104).

When it is determined that the vehicle occupant is seated, the processor additionally analyzes the height of the vehicle occupant seated on the vehicle seat (S1105).

The processor is configured to control the vibrator provided in the vehicle seat where the vehicle occupant is seated to output a vibration signal linked with music. In the instant case, the processor may adjust the magnitude of the vibration signal according to the age estimated from the result of the height analysis of the vehicle occupant (S1106).

The processor is configured to perform control so that the vibration signal linked with music is not output to a vehicle seat for which it is determined that no vehicle occupant is seated (S1107).

In the instant case, the processor may additionally analyze the constituent material of the object placed on the vehicle seat if necessary.

The term “unit” used in the exemplary embodiment of the present disclosure refers to a software or hardware component such as a field-programmable gate array (FPGA) or an application-specific integrated circuit (ASIC), and a “unit” performs a certain role. However, a “unit” is not limited to software or hardware. A “unit” may reside in an addressable storage medium and may be configured to regenerate one or more processors. Accordingly, as an exemplary embodiment of the present disclosure, a “unit” includes a component such as a software component, an object-oriented software component, a class component, a task component, etc., a process, a function, an attribute, a procedure, a subroutine, a segment of program code, a driver, firmware, microcode, a circuit, data, a database, a data structure, a table, an array, or a variable. The functions provided within the components and “units” may be combined into a smaller number of components and “units” or may be further separated into additional components and “units.” Furthermore, components and “units” may be implemented to regenerate one or more CPUs within a device or a secure multimedia card.

The device and method for determining seat occupancy according to various exemplary embodiments can accurately determine whether each vehicle seat is occupied by a vehicle occupant.

Furthermore, the device and method for determining seat occupancy can determine the physical condition of the vehicle occupant occupying the vehicle seat.

Furthermore, the device and method for determining seat occupancy can determine an object occupying the vehicle seat.

Furthermore, the device and method for determining seat occupancy can transmit vibration to the vehicle seat in connection with output music.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for determining seat occupancy, the apparatus comprising:
a vibrator which is provided on a seat back of a vehicle seat and outputs a vibration signal;
a detection unit which is provided on a seat bottom portion of the vehicle seat, receives the vibration signal transmitted through an object located on the vehicle seat, and generates a counting signal corresponding to the received vibration signal; and
a processor that is configured to determine whether a vehicle occupant is seated on the vehicle seat by analyzing the counting signal.

2. The apparatus of claim 1, wherein the processor is further configured to determine whether the vehicle occupant is seated and to determine a height of the vehicle occupant by analyzing a frequency and a delay of the counting signal.

3. The apparatus of claim 2, wherein the processor is further configured to determine a constituent material of the object located on the vehicle seat by analyzing the frequency and the delay of the counting signal.

4. The apparatus of claim 3, wherein the processor is further configured to conclude that the vehicle occupant is seated on the vehicle seat in response that the frequency of the counting signal is the same as a frequency of the vibration signal within a predetermined error range and the delay of the counting signal is within a predetermined reference range.

5. The apparatus of claim 3, wherein the processor is further configured to determine the height of the vehicle occupant using a delay value of the counting signal.

6. The apparatus of claim 3, wherein the processor is further configured to determine the constituent material of the object using a delay value of the counting signal.

7. The apparatus of claim 1, wherein the processor is further configured to control an operation of the vibrator so that a first frequency of the vibration signal is different from a second frequency generated during engine vibration.

8. The apparatus of claim 1, wherein the detection unit includes:
a mat including a liquid that moves in connection with the vibration signal; and
a sensor that produces the counting signal according to pressure generated by the movement of the liquid.

9. The apparatus of claim 1, wherein the detection unit includes a first detection unit and a second detection unit disposed at locations corresponding to both thighs of the vehicle occupant.

10. The apparatus of claim 9, wherein the processor is further configured to determine whether the vehicle occupant is seated on the vehicle seat by comparing and analyzing a first counting signal generated by the first detection unit and a second counting signal generated by the second detection unit.

11. The apparatus of claim 7, wherein the processor is further configured to control the operation of the vibrator provided on the vehicle seat where the vehicle occupant is seated in connection with music.

12. A method of determining seat occupancy, the method comprising:
outputting, by a vibrator provided on a seat back of a vehicle seat, a vibration signal;
receiving, by a detection unit provided on a seat bottom portion of the vehicle seat, the vibration signal transmitted through an object located on the vehicle seat;
generating, by the detection unit, a counting signal corresponding to the vibration signal received by the detection unit; and
determining, by a processor, whether a vehicle occupant is seated on the vehicle seat by analyzing the counting signal.

13. The method of claim 12, wherein, in the determining of whether the vehicle occupant is seated, the processor is configured to conclude that the vehicle occupant is seated on the vehicle seat in response that a frequency of the counting signal is the same as a frequency of the vibration signal within a predetermined error range and a delay of the counting signal is within a predetermined reference range.

14. The method of claim 12, further including determining, by the processor, a height of the vehicle occupant by analyzing a frequency and a delay of the counting signal.

15. The method of claim 14, wherein, in the determining of the height of the vehicle occupant, the processor is configured to determine the height of the vehicle occupant using a delay value of the counting signal.

16. The method of claim 12, further including determining, by the processor, a constituent material of the object located on the vehicle seat by analyzing a frequency and a delay of the counting signal.

17. The method of claim 16, wherein, in the determining of the constituent material of the object, the processor is configured to determine the constituent material of the object using a delay value of the counting signal.

18. The method of claim 12, wherein the outputting of the vibration signal includes controlling, by the processor, an operation of the vibrator so that a first frequency of the vibration signal is different from a second frequency generated during engine vibration.

19. The method of claim 12,
wherein the detection unit includes a first detection unit and a second detection unit, and
wherein the determining of whether the vehicle occupant is seated on the vehicle seat includes determining, by the processor, whether the vehicle occupant is seated on the vehicle seat by comparing and analyzing a first counting signal generated by the first detection unit and a second counting signal generated by the second detection unit.

20. The method of claim 12, further including controlling, by the processor, an operation of the vibrator provided on the vehicle seat where the vehicle occupant is seated in connection with music.
